(19) United States
(12) Patent Application Publication
(10) Pub. No.: US 2015/0056905 A1
(43) Pub. Date: Feb. 26, 2015

(54) OXYGEN SUPPLY ELEVATOR

(71) Applicant: CIJ CO., LTD, Daejeon (KR)

(72) Inventor: Jong Tae Baek, Daejeon (KR)

(73) Assignee: CIJ CO., LTD., Daejeon, KR (unknown)

(21) Appl. No.: 14/385,170

(22) PCT Filed: Mar. 18, 2013
(86) PCT No.: PCT/KR2013/002203

§ 371 Date: Oct. 24, 2014

(30) Foreign Application Priority Data
Mar. 16, 2012 (KR) 10-2012-0026985

(51) Int. Cl. B66B 5/02; A62B 18/02; B66B 11/02; A62B 9/02

(52) U.S. Cl. CPC B66B 5/024; A62B 9/02; A62B 18/02; B66B 11/024
USPC 454/68; 128/204.21

(57) ABSTRACT

Oxygen supply elevator which supplies oxygen to an internal space of the elevator or a separate oxygen mask provided in the elevator, thereby allowing a user to easily breathe and removing smoke or the like. The oxygen supply elevator includes: an oxygen containing unit which is provided in a facility mounting space formed on the elevator and contains oxygen at pressure higher than atmospheric pressure; an oxygen supply unit which is connected with the oxygen containing unit through at least one communication channel and supplies oxygen to an oxygen supply space in the elevator; a valve unit which is provided on the communication channel and adjusts a flow rate of oxygen discharged from the oxygen containing unit; and a control unit which is connected to the valve unit and adjusts whether to open or close the valve unit or an opening amount of the valve unit.

### TECHNICAL FIELD

The present invention relates to an oxygen supply elevator. More particularly, the present invention relates to an oxygen supply elevator which supplies oxygen to an internal space of the elevator or a separate oxygen mask provided in the elevator, thereby allowing a passenger to easily breathe, and removing smoke or the like.

### BACKGROUND ART

When a disaster situation such as fires, a release of toxic gas, a terror attack, and a chemical, biological or radiological accident occurs in a building, it is necessary to allow persons in the building to safely breathe without breathing in a toxic material while the persons get to a safe place. Particularly, it has been countlessly pointed out that in a fire site in a high-rise building such as an apartment, accidents due to suffocation frequently occur more than burns.

Meanwhile, elevators are necessarily installed in the high-rise buildings for convenience. However, the elevator does not have a hermetic structure, and air circulates over all floors, such that the elevator actually serves as a chimney in the building at the time of a fire. Therefore, possibility of a passenger suffocating due to being locked in a smoky elevator may be more increased when the passenger rides in the elevator at the time of a fire. There have been reports where smoke leaks into an elevator of a neighboring building, which is not the building on fire, and suffocated the passenger. Because of the aforementioned dangerousness, most countries prohibit persons from riding in the elevator at the time of a fire in the high-rise building.

However, in consideration of a report that reported at the time of the terror attack on the World Trade Center in New York City in 2001, it took one hour for a healthy person to get down to the 1st floor from the 95th floor by going down the stairs; in respect to the time it took to escape a high-rise building, it is necessary to provide a method of allowing persons to evacuate the super high-rise building by using the elevator which includes any countermeasure. Particularly, in a fire in the high-rise building, indirect injuries of an accident due to inhalation of a toxic material such as smoke are wider and more frequent than direct injuries of accident due to fire, and as a result, wherever the persons are, the need to allow the persons to quickly evacuate the building is increased. The Fire Services Act in Korea currently prohibits the person from using the elevator at the time of fire, but the regulations in foreign countries are already being improved so as to permit the use of the elevator at the time of a fire in a high-rise building, and this trend will be expected to be introduced even in Korea.

In a disaster situation in a high-rise building, a method of preventing the persons from breathing in smoke or the like when the persons evacuate the building is required among other things. In this case, in a case in which the regulation, which permits the persons to use the elevator when evacuating the building, is introduced, it is of course very important to make smoke not leak into the elevator, or the persons breathe in clean air in the elevator.

Korean Patent Application Laid-Open No. 2008-0085120 (“SMOKE PROTECTION STRUCTURE OF ELEVATOR PASSAGE”, Sep. 23, 2008, hereinafter, referred to as Literature 1) discloses a structure which prevents smoke from flowing into an elevator passage by installing an air supply device in the elevator passage, and raising atmospheric pressure by forcedly allowing air to flow into the elevator passage at the time of a fire. Literature 1 may be partly effective in that passengers in the elevator may breathe in clean air instead of air mixed with smoke or a toxic material by preventing smoke from flowing into the elevator passage, but there are problems in that a significantly large amount of air needs to be drawn in order to raise atmospheric pressure in the elevator passage to a degree at which smoke may not flow in, energy is significantly wasted during this process because a significant load is applied, and it is difficult to perform a quick countermeasure. In addition, in the case of a super high-rise building, it may be impossible to pressurize the entire elevator passage because a height of the elevator passage is very great, and if there is an air gap at the floor that has the fire, a large amount of high-pressure air flows through the gap, which causes even a bigger fire, and as a result, there is a fatal problem in that damage to property and injuries are rather greatly increased.

On the other hand, Korean Utility Model Registration No. 1993-0007072 (“VENTILATION DEVICE FOR ELEVATOR”, Oct. 11, 1993, hereinafter, referred to as Literature 2) discloses a configuration which has an air inlet or an air outlet in an internal space of an elevator in order to reduce air resistance when the elevator moves upward or downward, and allow the elevator to more efficiently move upward or downward. According to Literature 2, since air smoothly flows into the elevator, there may be an effect of ventilating the elevator at normal times, but in a case in which smoke, a toxic material, and the like are mixed with outside air in a disaster situation such as a fire, there is a problem in that the outside air mixed with smoke or a toxic material additionally causes danger to the passengers due to inhalation in the elevator.

### LITERATURE OF RELATED ART

### (Patent Literature)

1. Korean Patent Application Laid-Open No. 2008-0085120 (“SMOKE PROTECTION STRUCTURE OF ELEVATOR PASSAGE”, Sep. 23, 2008)

2. Korean Utility Model Registration No. 1993-0007072 (“VENTILATION DEVICE FOR ELEVATOR”, Oct. 11, 1993)

### DISCLOSURE

### [Technical Problem]

Accordingly, the present invention has been made in an effort to solve the problems in the related art, and an object of the present invention is to provide an oxygen supply elevator which prevents outside air mixed with smoke from flowing into the elevator in a disaster situation such as a fire, and allows passengers in the elevator to maximally breathe in clean oxygen.

### [Technical Solution]

To achieve the aforementioned object, an oxygen supply elevator (100) of the present invention includes: an oxygen containing unit (10) which is provided in a facility mounting space (S2) formed on the elevator and contains oxygen at pressure higher than atmospheric pressure; an oxygen supply unit (20) which is connected with the oxygen containing unit (10) through at least one communication channel (30) and supplies oxygen to an oxygen supply space (S1) in the elevator; a valve unit (40) which is provided on the communication channel (30) and adjusts a flow rate of oxygen discharged from the oxygen containing unit (10); and a control unit (50) which is connected to the valve unit (40) and adjusts whether to open or close the valve unit (40) or an opening amount of the valve unit (40).

In this case, the oxygen containing unit (10) may be formed in the form of a container filled with at least one selected from high-pressure oxygen at pressure higher than atmospheric pressure, high-pressure air at pressure higher than atmospheric pressure, liquefied oxygen made by liquefying oxygen, and liquefied air made by liquefying air, in the form of an oxygen generator which generates oxygen, or in the form of a pipe which is supplied with oxygen or air from the outside.

In addition, the oxygen containing unit (10) may have a recognition means (11) that recognizes an amount of remaining oxygen contained in the oxygen containing unit (10). In this case, the oxygen containing unit (10) may have a warning means (12) which is connected with the recognition means (11) and warns of a state in which an amount of remaining oxygen is a predetermined reference value or less. In addition, in this case, the warning means (12) may be formed in at least one form selected from a form which outputs an alarm signal in the form of sound, light, or a letter or a picture displayed on a screen, a form which transmits and outputs a rescue message to the outside, and a form which receives an evacuation signal from the outside and outputs the evacuation signal.

In addition, the oxygen supply unit (20) may be formed in at least one form selected from a form in which the oxygen supply space (S1) is an internal space of the elevator (100) and oxygen is supplied directly into the elevator (100), and a form in which the oxygen supply space (S1) is at least one oxygen mask provided in the elevator (100) and oxygen is supplied to the oxygen mask.

In addition, the valve unit (40) may further include a safety means which automatically discharges a part or the entirety of oxygen in the oxygen containing unit (10) when pressure and a temperature in the oxygen containing unit (10) are a predetermined reference value or more.

In addition, the control unit (50) may be formed in at least one form selected from a form which is formed in the form of a button and performs an operation of opening and closing the valve unit (40) by input from a user, a form which is connected to an external control room and performs an operation of remotely opening and closing the valve unit (40) by input from an administrator, a form which is connected with a fire detecting sensor provided on a wall surface of a building and performs an operation of opening and closing the valve unit (40) when fire is detected, and a form which is connected with a fire emergency bell system in a building and performs an operation of opening and closing the valve unit (40) in conjunction with the fire emergency bell system when the fire emergency bell is operated.

In addition, the control unit (50) may adjust a flow rate of oxygen being discharged so that pressure in the oxygen supply space (S1) is maintained to positive pressure higher than atmospheric pressure.

In addition, the control unit (50) may have a separate power source unit including a battery.

In addition, the oxygen supply elevator may further include a central control unit (60) which is connected to the respective control units (50) provided in the respective elevators (100), and remotely manages the respective control units (50) in a unified manner, when one or more elevators 100 are provided, in which the central control unit (60) individually recognizes the respective elevators (100), and separately operates the respective control units (50) provided in the respective elevators (100).

### [Advantageous Effects]

According to the present invention, there is a great advantage in that the passengers in the elevator may breathe in clean oxygen in an emergency situation such as a fire. In more detail, according to the present invention, breathing of the passenger may be maintained by supplying oxygen at pressure higher than atmospheric pressure to the internal space of the elevator or the mask respiration space in a situation in which the passenger is locked in the elevator due to power failure or the like, or in a dangerous situation in which smoke or toxic gas is spread into the elevator due to fire or the like, thereby greatly reducing dangerousness such as difficulty in breathing or death by suffocation until the passengers can get to the safe floor.

Furthermore, according to the present invention, there is an advantage in that oxygen at pressure higher than atmospheric pressure is supplied into the elevator, thereby pushing and removing smoke flowing into the elevator to the outside at the time of a fire, or thereby preventing smoke from flowing into the elevator.

### DESCRIPTION OF DRAWINGS

FIG. 1 is a block diagram of a configuration of an oxygen supply elevator of the present invention.

FIG. 2 illustrates an exemplary embodiment of a configuration of the oxygen supply elevator of the present invention.

FIG. 3 illustrates an exemplary embodiment of auxiliary means provided in an oxygen containing unit of the present invention.

FIG. 4 illustrates various exemplary embodiments of the oxygen supply unit of the present invention.

FIG. 5 illustrates another exemplary embodiment of the oxygen supply elevator of the present invention.

### DESCRIPTION OF MAIN REFERENCE NUMERALS OF DRAWINGS

100: Elevator
10: Oxygen containing unit
11: Recognition means
12: Warning means
20: Oxygen supply unit
30: Communication channel
40: Valve unit
50: Control unit
60: Central control unit
S1: Oxygen supply space
S2: Facility mounting space

### BEST MODE

Hereinafter, an oxygen supply elevator according to the present invention, which has the aforementioned configuration, will be described in detail with reference to the accompanying drawings.

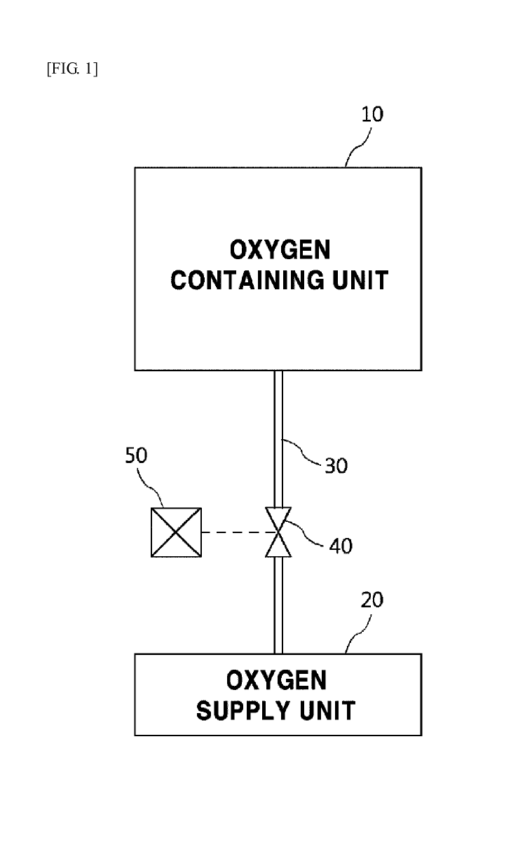

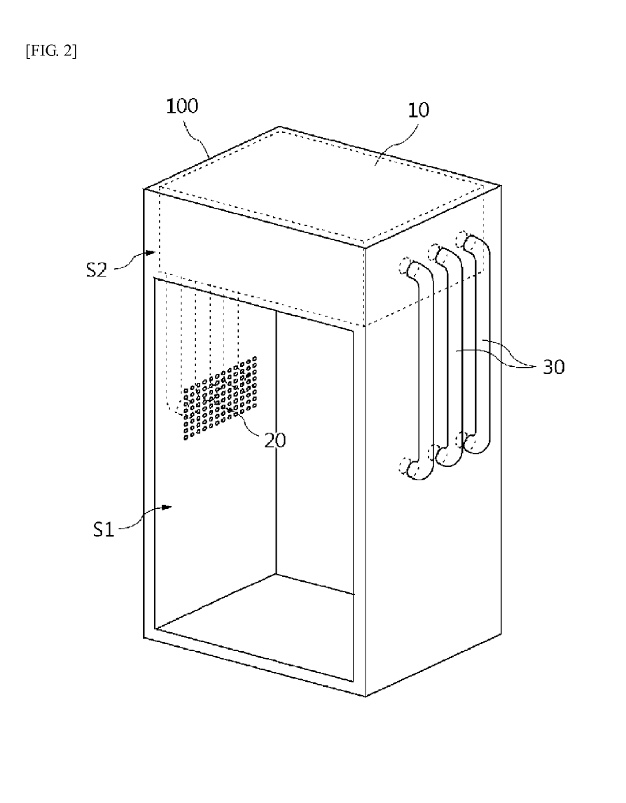

FIG. 1 is a block diagram of a configuration of an oxygen supply elevator of the present invention, and FIG. 2 illustrates an exemplary embodiment of a configuration of the oxygen supply elevator of the present invention. The oxygen supply elevator of the present invention, when briefly summarized, serves to supply oxygen into an elevator in an emergency situation such as a fire, and allows passengers in the elevator to breathe in clean air instead of air mixed with smoke. Hereinafter, the term ‘smoke’ is used as a meaning including smoke, toxic materials, and the like, and the term ‘oxygen’ is used as a meaning including not only pure oxygen but also air mixed with oxygen as gas required to allow humans to breathe.

As illustrated in FIGS. 1 and 2, an oxygen supply elevator 100 of the present invention includes an oxygen containing unit 10, an oxygen supply unit 20, a communication channel 30, a valve unit 40, and a control unit 50, and oxygen contained in the oxygen containing unit 10 is supplied to the oxygen supply unit 20 through the communication channel 30, such that passengers in the elevator 100 may breathe in clean oxygen. The valve unit 40 and the control unit 50 are used to control the aforementioned supply operation. Hereinafter, the respective units will be described in more detail.

The oxygen containing unit 10 will be described. As illustrated in FIG. 2, the oxygen containing unit 10 is provided in a facility mounting space S2 formed on the elevator, and contains oxygen at pressure higher than atmospheric pressure. The facility mounting space S2 may be the exterior of the elevator 100, or may be a separate space formed in a frame that constitutes the elevator 100. In a case in which the facility mounting space S2 is the exterior of the elevator 100, there is generally a problem in that a size of a passage for the elevator 100 is restricted, and thus it is preferred that the facility mounting space S2 is an upper portion of the elevator 100 or a lower portion of the elevator 100 rather than a side portion of the elevator 100. Of course, even in a case in which the facility mounting space S2 is formed as a separate space formed integrally with the elevator 100, various modified exemplary embodiments are possible, such as the facility mounting space S2 being disposed on the upper portion of the elevator 100 as illustrated in FIGS. 1 and 2, or disposed on the lower portion of the elevator 100.

The oxygen containing unit 10 is a means for containing oxygen to be supplied into the elevator 100, and may have any shape as long as the oxygen containing unit 10 may supply oxygen. As a configuration that may be easily considered, the oxygen containing unit 10 may be formed in the form of a container filled with at least one selected from high-pressure oxygen at pressure higher than atmospheric pressure, high-pressure air at pressure higher than atmospheric pressure, liquefied oxygen made by liquefying oxygen, and liquefied air made by liquefying air. However, the oxygen containing unit 10 is not limited to the container shape containing oxygen or air, but the oxygen containing unit 10 may be formed in any shape, such as an oxygen generator which generates oxygen, or a pipe which is supplied with oxygen or air from the outside, for example, as long as the oxygen containing unit 10 has a shape that may supply oxygen.

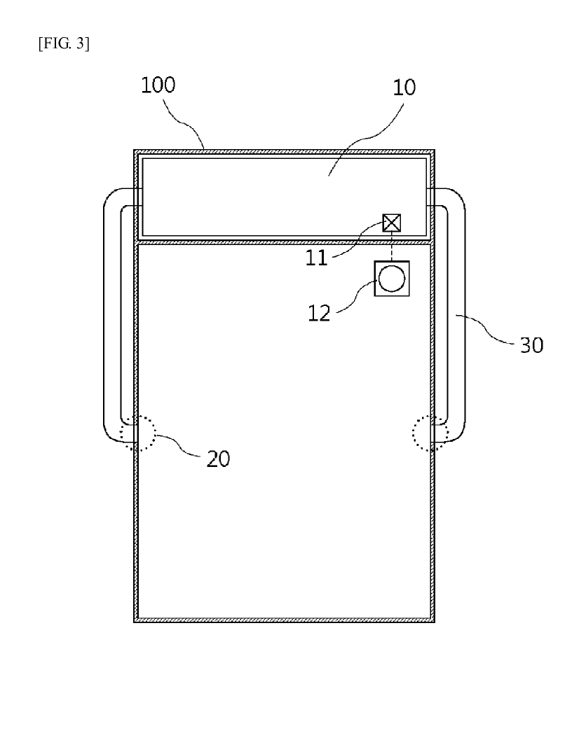

In addition, it is preferred that the oxygen containing unit 10 further includes various auxiliary means for improving maintainability and safety. FIG. 3 illustrates an exemplary embodiment of auxiliary means provided in the oxygen containing unit of the present invention. First, it is preferred that the oxygen containing unit 10 has a recognition means 11 that recognizes an amount of remaining oxygen contained in the oxygen containing unit 10. Since the recognition means 11 is provided, when an amount of remaining oxygen is not sufficient at the time of maintenance at normal times, the recognition means 11 quickly recognizes the insufficient amount of remaining oxygen, such that an operation of filling the oxygen containing unit 10 with oxygen may be performed. In addition, in a situation in which oxygen is supplied from the oxygen containing unit 10 in an emergency situation, the recognition means 11 recognizes an amount of remaining oxygen, such that the recognized amount of remaining oxygen may be used to cope with the emergency situation. Specifically, it is preferred that the oxygen containing unit 10 further includes a warning means 12 which is connected with the recognition means 11 and warns of a state in which an amount of remaining oxygen is a predetermined reference value or less. In this case, the warning means 12 may be formed in at least one form selected from a form which outputs an alarm signal in the form of sound, light, or a letter or a picture displayed on a screen, a form which transmits and outputs a rescue message to the outside, and a form which receives an evacuation signal from the outside and outputs the evacuation signal.

The oxygen supply unit 20 will be described. The oxygen supply unit 20 is connected with the oxygen containing unit 10 through at least one communication channel 30, and serves to supply oxygen to an oxygen supply space 51 in the elevator. That is, the oxygen supply unit 20 is called a means from which oxygen supplied from the oxygen containing unit 10 is discharged.

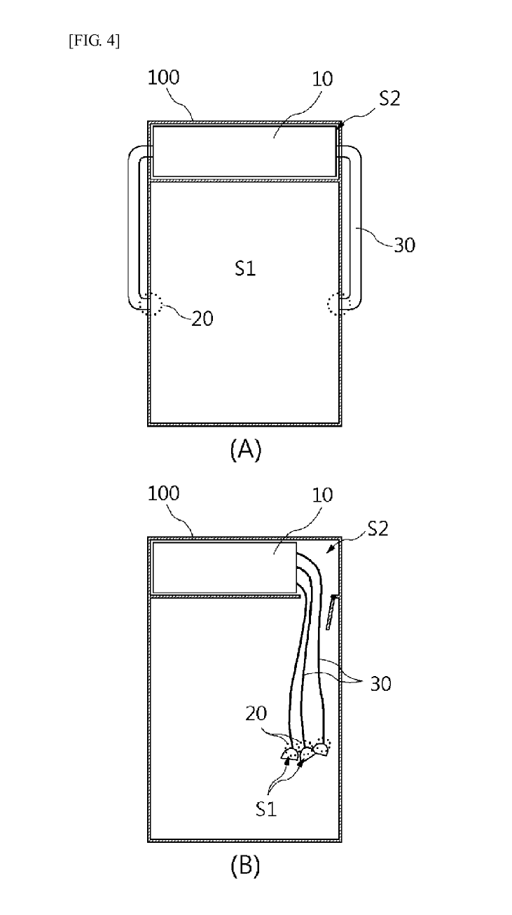

The oxygen supply unit 20 may have various forms, and FIG. 4 illustrates various exemplary embodiments of the oxygen supply unit of the present invention. First, as illustrated in FIG. 4A, the oxygen supply unit 20 may be formed in a form in which the oxygen supply space S1 is an internal space of the elevator 100 and oxygen is supplied directly into the elevator 100. Otherwise, as illustrated in FIG. 4B, the oxygen supply unit 20 may be formed in a form in which the oxygen supply space S1 is at least one oxygen mask provided in the elevator 100 and oxygen is supplied to the oxygen mask. In a case in which the oxygen supply space S1 is in the form of the oxygen mask, a means, which provides the oxygen mask accommodated in the facility mounting space S2 to the passenger in the elevator 100 in an emergency situation so that the passenger uses the oxygen mask, may be further provided.

The various exemplary embodiments of the oxygen supply unit 20 may be separately provided, or may be provided together. That is, for example, the form which supplies oxygen directly into the internal space of the elevator 100 as illustrated in FIG. 4A, and the form which supplies oxygen through the oxygen masks separately provided as illustrated in FIG. 4B may be all provided together. Of course, in addition to the aforementioned configuration, the oxygen supply unit 20 may have any other configurations as long as the oxygen supply unit 20 may effectively supply oxygen into the elevator 100, and allow the passengers to easily breathe in clean oxygen.

The valve unit 40 will be described. The valve unit 40 is provided on the communication channel 30, and serves to adjust a flow rate of oxygen discharged from the oxygen containing unit 10. That is, the valve unit 40 is operated depending on whether the valve unit 40 is fully opened, what percentage of the valve unit 40 is opened, whether the valve unit 40 is fully closed, and the like, and as a result, a flow rate of oxygen being discharged may be adjusted. Because the valve unit 40 itself is not an active means, and an operation of adjusting whether to open or close the valve unit 40 or an opening degree of the valve unit 40 is performed by the control unit 40 which will be described below, the operation will be described in more detail below.

Meanwhile, as described above, the oxygen containing unit 10 may contain high-pressure oxygen at pressure higher than atmospheric pressure, and as a result, there may be a risk that the oxygen containing unit 10 explodes when a temperature is raised in a disaster situation such as a fire. In order to solve the aforementioned problem, it is preferred that the valve unit 40 further includes a safety means which automatically discharges a part or the entirety of oxygen in the oxygen containing unit 10 when pressure and a temperature in the oxygen containing unit 10 are a predetermined reference value or more.

The control unit 50 will be described. As described above, the control unit 50 is connected to the valve unit 40, and serves to adjust whether to open or close the valve unit 40 or an opening degree of the valve unit 40.

The control unit 50 needs to be configured to close the valve unit 40 at normal times, and to properly open the valve unit 40 in a disaster situation such as a fire so as to supply oxygen into the elevator 100. For example, the control unit 50 may have a form which is formed in the form of a button and performs an operation of opening and closing the valve unit 40 by input from a user, a form which is connected to an external control room and performs an operation of remotely opening and closing the valve unit 40 by input from an administrator, a form which is connected with a fire detecting sensor provided on a wall surface of a building and performs an operation of opening and closing the valve unit 40 when fire is detected, and a form which is connected with a fire emergency bell system in a building and performs an operation of opening and closing the valve unit 40 in conjunction with the fire emergency bell system when the fire emergency bell is operated. Of course, in addition to the aforementioned configuration, the control unit 50 may have any other form as long as the control unit 50 may properly supply oxygen into the elevator 100 in a disaster situation.

As described above, the control unit 50 serves to properly open the valve unit 40 so that oxygen is supplied into the elevator 100. In this case, when an excessively large amount of oxygen is supplied into the elevator 100, there is a risk that oxygen in the oxygen containing unit 10 is rapidly consumed, or when an excessively small amount of oxygen is supplied, the supply of oxygen may be meaningless. In consideration of the aforementioned points, it is preferred that the control unit 50 adjusts a flow rate of oxygen being discharged so that pressure in the oxygen supply space S1 is maintained to positive pressure higher than atmospheric pressure. Here, pressure in the oxygen supply space S1 is maintained to positive pressure higher than atmospheric pressure, thereby preventing outside air (mixed with smoke in a disaster situation) from leaking into the elevator 100 (or into the oxygen mask). Furthermore, by allowing air to naturally flow from the inside of the elevator to the outside of the elevator, the smoke may be discharged even though a part of the smoke leaks into the elevator 100.

It is also preferred that the control unit 50 has a separate power source unit including a battery. In a case in which power being supplied in a building or an elevator is shared, the power may be cut off in a disaster situation such as a fire. However, the control unit 50 has the separate power source unit as described above, and as a result, even when power failure occurs, oxygen may be supplied into the elevator 100 without being absolutely affected by the power failure.

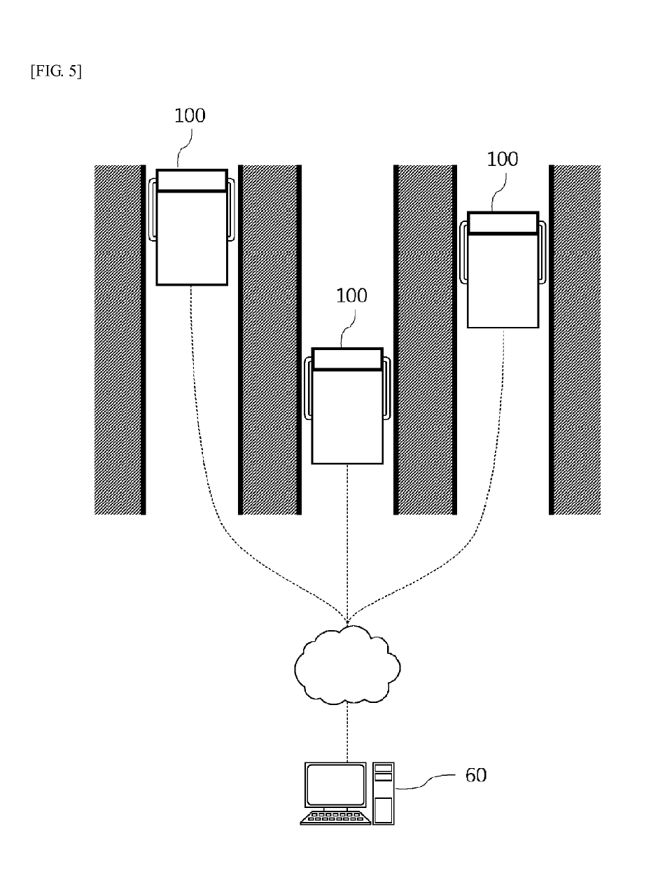

FIG. 5 illustrates another exemplary embodiment of the oxygen supply elevator of the present invention. It has been described above that various types of operation controls are independently performed for the individual elevator, but actually, one or more elevators are mostly installed in a building, and it is of course preferred that separate control is performed for each of the elevators when the plurality of elevators is installed in a building.

Accordingly, in a case in which one or more elevators 100 are installed as illustrated in FIG. 5, it is preferred that the oxygen supply elevator of the present invention further includes a central control unit 60 which is connected to the respective control units 50 provided in the respective elevators 100, and remotely manages the respective control units 50 in a unified manner. The central control unit 60 individually recognizes the respective elevators 100, and separately operates the respective control units 50 provided in the respective elevators 100. That is, for example, when fire breaks out in any one line, oxygen is supplied by operating the control unit 50 provided in the elevator 100 in the corresponding line, and the control unit 50 provided in the elevator 100 in another line is not operated. If all of the control units 50 in the plurality of elevators 100 are operated at the time of a fire, oxygen contained is consequently wasted in the line where fire does not actually spread. However, when the central control unit 60 controls separate operations as described above, the problem about wasting oxygen may be prevented. The individual recognition of the elevator 100 may be variously specified by using a unique ID provided to the elevator 100 in advance, or by providing a unique ID to the control unit 50, and because the ways to provide the unique IDs to the plurality of devices are widely and publicly known, any one of the ways may be adopted.

The present invention is not limited to the aforementioned exemplary embodiment, and may be variously applied, and various modified exemplary embodiments may be made by those skilled in the technical field to which the present invention pertains without departing from the subject matter of the present invention claimed in the claims.

1. An oxygen supply elevator comprising:
an oxygen containing unit which is provided in a facility mounting space formed on the elevator and contains oxygen at pressure higher than atmospheric pressure;
an oxygen supply unit which is connected with the oxygen containing unit through at least one communication channel and supplies oxygen to an oxygen supply space in the elevator;
a valve unit which is provided on the communication channel and adjusts a flow rate of oxygen discharged from the oxygen containing unit; and
a control unit which is connected to the valve unit and adjusts whether to open or close the valve unit or an opening amount of the valve unit.

2. The oxygen supply elevator of claim 1, wherein the oxygen containing unit is formed in the form of a container filled with at least one selected from high-pressure oxygen at pressure higher than atmospheric pressure, high-pressure air at pressure higher than atmospheric pressure, liquefied oxygen made by liquefying oxygen, and liquefied air made by liquefying air, in the form of an oxygen generator which generates oxygen, or in the form of a pipe which is supplied with oxygen or air from the outside.

3. The oxygen supply elevator of claim 1, wherein the oxygen containing unit has a recognition means that recognizes an amount of remaining oxygen contained in the oxygen containing unit.

4. The oxygen supply elevator of claim 3, wherein the oxygen containing unit has a warning means which is connected with the recognition means and warns of a state in which an amount of remaining oxygen is a predetermined reference value or less.

5. The oxygen supply elevator of claim 4, wherein the warning means is formed in at least one form selected from a form which outputs an alarm signal in the form of sound, light, or a letter or a picture displayed on a screen, a form which transmits and outputs a rescue message to the outside, and a form which receives an evacuation signal from the outside and outputs the evacuation signal.

6. The oxygen supply elevator of claim 1, wherein the oxygen supply unit is formed in at least one form selected from a form in which the oxygen supply space is an internal space of the elevator and oxygen is supplied directly into the elevator, and a form in which the oxygen supply space is at least one oxygen mask provided in the elevator and oxygen is supplied to the oxygen mask.

7. The oxygen supply elevator of claim 1, wherein the valve unit further includes a safety means which automatically discharges a part or the entirety of oxygen in the oxygen containing unit when pressure and a temperature in the oxygen containing unit are a predetermined reference value or more.

8. The oxygen supply elevator of claim 1, wherein the control unit is formed in at least one form selected from a form which is formed in the form of a button and performs an operation of opening and closing the valve unit by input from a user, a form which is connected to an external control room and performs an operation of remotely opening and closing the valve unit by input from an administrator, a form which is connected with a fire detecting sensor provided on a wall surface of a building and performs an operation of opening and closing the valve unit when fire is detected, and a form which is connected with a fire emergency bell system in a building and performs an operation of opening and closing the valve unit in conjunction with the fire emergency bell system when the fire emergency bell is operated.

9. The oxygen supply elevator of claim 1, wherein the control unit adjusts a flow rate of oxygen being discharged so that pressure in the oxygen supply space is maintained to positive pressure higher than atmospheric pressure.

10. The oxygen supply elevator of claim 1, wherein the control unit has a separate power source unit including a battery.

11. The oxygen supply elevator of claim 1, further comprising:
a central control unit which is connected to the respective control units provided in the respective elevators, and remotely manages the respective control units in a unified manner, when one or more elevators are provided,
wherein the central control unit individually recognizes the respective elevators, and separately operates the respective control units provided in the respective elevators.
